(19) United States
(12) Patent Application Publication
(10) Pub. No.: US 2025/0286083 A1
(43) Pub. Date: Sep. 11, 2025

(54) METHOD OF MANUFACTURING CATALYST AND ELECTRODE USING SUPERCRITICAL FLUID

(71) Applicant: KOREA INSTITUTE OF SCIENCE AND TECHNOLOGY, Seoul (KR)

(72) Inventors: Sung Jong YOO, Seoul (KR); Jung Woo SHIM, Seoul (KR); Jae-hyun PARK, Seoul (KR); Bora SEO, Seoul (KR); Katie Heeyum LIM, Seoul (KR); Hee-Young PARK, Seoul (KR); Sung Ki CHO, Seoul (KR); Hyun Seo PARK, Seoul (KR); So Young LEE, Seoul (KR); Jin Young KIM, Seoul (KR); Jong Hyun JANG, Seoul (KR)

(73) Assignee: KOREA INSTITUTE OF SCIENCE AND TECHNOLOGY, Seoul (KR)

(21) Appl. No.: 19/076,292

(22) Filed: Mar. 11, 2025

(30) Foreign Application Priority Data
Mar. 11, 2024 (KR) 10-2024-0034154

(51) Int. Cl. H01M 4/88; H01M 4/86; H01M 4/92; H01M 8/10; H01M 8/1018; H01M 8/12

(52) U.S. Cl. CPC H01M 4/8828; H01M 4/8668; H01M 4/926; H01M 8/1018; H01M 8/12; H01M 2008/1095; H01M 2008/1293

(57) ABSTRACT

The present disclosure relates to a method for preparing a catalyst and an electrode using a supercritical fluid. A method for preparing an ink slurry according to the present disclosure allows the preparation of an ink slurry with improved dispersibility in large quantities in a simple and environmentally friendly manner.

### CROSS-REFERENCE TO RELATED APPLICATION

This application claims priority of Korean Patent Application No. 10-2024-0034154 filed on Mar. 11, 2024, in the Korean Patent Office, and all the benefits accruing therefrom under 35 U.S.C. § 119, the entire contents of which are herein incorporated by reference for all purposes.

### BACKGROUND

### 1. Field

The present disclosure relates to a method for preparing a catalyst and an electrode using a supercritical fluid.

### 2. Description of the Related Art

Recently, as interest in renewable energy has increased, researches on fuel cells, secondary batteries, solar cells, etc. are being conducted actively. In various fields, electrodes are prepared by mixing solvents, solutes, and binders in the form of an ink slurry, using spraying, slot die, blading, or roll-to-roll processes. If the dispersibility of the ink slurry is low, the quality of the electrode deteriorates, which adversely affects the performance and durability of the electrode. To solve this problem, various physical methods such as bath and probe sonication, ball mills, magnetic stirrers, etc. are used, or methods of improving the dispersibility of the ink slurry by adding additives are used. But, there is a problem that they are not sufficient to produce high-quality electrodes, or the quality of the electrodes deteriorates due to the additives. For this reason, it is important to develop a method to improve the dispersibility of a solvent in an ink slurry without using an additive.

### REFERENCES OF RELATED ART

### Patent Documents

Patent document 1. Korean Patent Publication No. 10-2021-0064638.

### SUMMARY

The present disclosure is directed to providing a method for preparing a catalyst ink slurry, capable of producing an ink slurry with improved dispersibility in a simple and environmentally friendly manner, and a catalyst ink slurry and an electrode prepared therefrom.

An aspect of the present disclosure provides a method for preparing a catalyst slurry, which includes: a carbon dioxide supply step of supplying carbon dioxide to a chamber containing a mixture of a catalyst and a binder added to a first solvent; a supercritical state creation step of increasing the pressure and temperature of the chamber to create a supercritical state; and a supercritical treatment step of supercritically treating the mixture under the supercritical state.

Another aspect of the present disclosure provides a method for preparing a catalyst slurry, which includes: a supercritical state creation step of creating a supercritical state by increasing the pressure and temperature of carbon dioxide; a carbon dioxide supply step of supplying the carbon dioxide in a supercritical state to a chamber containing a mixture of a catalyst and a binder added to a first solvent; and a supercritical treatment step of supercritically treating the mixture to which the supercritical carbon dioxide has been supplied.

The present disclosure provides a method for preparing a catalyst, which includes: a step of preparing a catalyst slurry by the method for preparing a catalyst slurry described above; and a step of preparing a catalyst by coating the catalyst slurry.

Another aspect of the present disclosure provides a catalyst slurry prepared by the method described above.

Another aspect of the present disclosure provides a catalyst containing the catalyst slurry.

Another aspect of the present disclosure provides a fuel cell including the catalyst.

The method for preparing an ink slurry according to the present disclosure allows the preparation of an ink slurry with improved dispersibility in large quantities in a simple and environmentally friendly manner.

The effect of the present disclosure is not limited to that mentioned above. It should be understood that the effects of the present disclosure include all the effects that can be inferred from the following description.

### BRIEF DESCRIPTION OF THE DRAWINGS

FIG. 1 shows the pressure-temperature phase diagram of carbon dioxide.

FIG. 2 illustrates a method for preparing a catalyst slurry according to an exemplary embodiment of the present disclosure.

FIG. 3 is a schematically shows the particle distribution in a catalyst slurry when dispersion is insufficient or sufficient.

FIG. 4 shows photographic images of ink slurries prepared in Example 1 and Comparative Example 1 of the present disclosure.

FIG. 5 shows a result of dynamic light scattering (DLS) analysis of ink slurries prepared in Example 1 and Comparative Example 1 of the present disclosure.

FIG. 6 shows the scanning electron microscopic (SEM) images of the surface of electrodes prepared in Example 1 and Comparative Example 1 of the present disclosure.

FIG. 7 shows a result of evaluating the electrochemical performance of fuel cells using electrodes prepared in Example 1 and Comparative Example 1 of the present disclosure before and after accelerated aging.

### DETAILED DESCRIPTION

The advantages and features of the present disclosure and the methods for achieving them will become apparent with reference to the exemplary embodiments described in detail below together with the accompanying drawings. However, the present disclosure is not limited to the embodiments disclosed below, but may be implemented in various different forms, and these embodiments are provided only to make the disclosure of the present disclosure complete and to fully inform a person having ordinary skill in the art to which the present disclosure pertains of the scope of the invention, and the present disclosure is defined only by the scope of the claims.

In describing the present disclosure, if it is determined that a detailed description of a related known technology may unnecessarily obscure the gist of the present disclosure, the detailed description will be omitted. When the words “include”, “have”, and “consist of”, etc. are used in this specification, other components may also be added, unless “only” is used. Furthermore, terms such as “include”, “have”, etc. should not be construed as excluding the presence or addition of one or more other features, numbers, steps, components, or combinations thereof, but rather as specifying the presence of the features, numbers, steps, components, or combinations thereof described in the specification. Additionally, when a component is expressed in singular form, it includes the presence of plural components unless there is a special explicit description.

Hereinafter, the present disclosure will be described in more detail.

When the dispersibility of an ink slurry is low, the quality of an electrode deteriorates, which adversely affects the performance and durability of the electrode. Therefore, various physical methods or methods of adding additives have been used to improve the dispersibility of the ink slurry, but there have been problems in that these methods are not sufficient to prepare a high-quality electrode or the quality of the electrode deteriorates due to the additives.

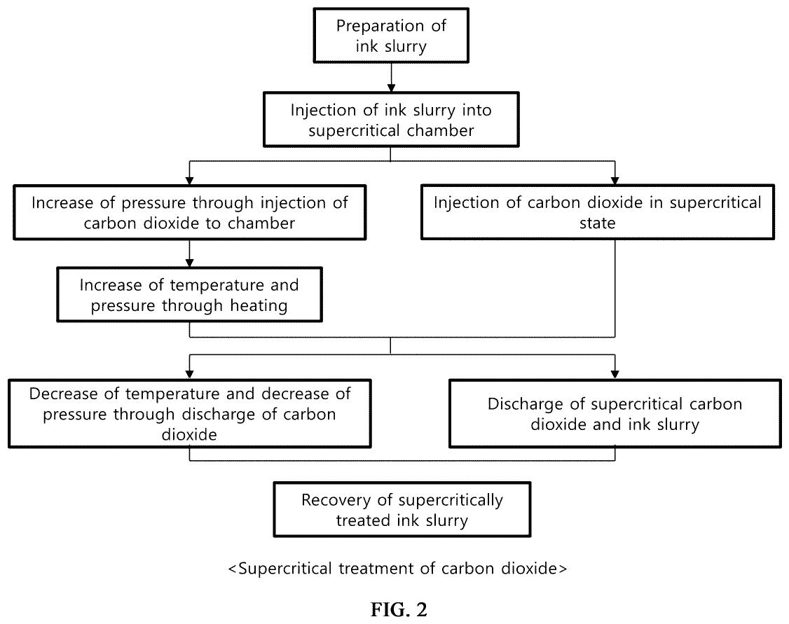

FIG. 2 illustrates a method for preparing a catalyst slurry according to an exemplary embodiment of the present disclosure.

As shown in FIG. 2, the present disclosure provides a method for preparing a catalyst slurry capable of improving the dispersibility of an ink slurry without using an additional additive, regardless of the type of a solvent, a solute, or a binder, using carbon dioxide in a supercritical state.

More specifically, an aspect of the present disclosure provides a method for preparing a catalyst slurry, which includes: a carbon dioxide supply step of supplying carbon dioxide to a chamber containing a mixture of a catalyst and a binder added to a first solvent; a supercritical state creation step of increasing the pressure and temperature of the chamber to create a supercritical state; and a supercritical treatment step of supercritically treating the mixture under the supercritical state.

Another aspect of the present disclosure provides a method for preparing a catalyst slurry, which includes: a supercritical state creation step of creating a supercritical state by increasing the pressure and temperature of carbon dioxide; a carbon dioxide supply step of supplying the carbon dioxide in a supercritical state to a chamber containing a mixture of a catalyst and a binder added to a first solvent; and a supercritical treatment step of supercritically treating the mixture to which the supercritical carbon dioxide has been supplied.

### Carbon Dioxide Supply Step

The carbon dioxide supply step is a step of supplying carbon dioxide to a chamber containing a mixture of a catalyst and a binder added to a first solvent.

The carbon dioxide may or may not be in a supercritical state. More specifically, as described above, the method for preparing a catalyst slurry of the present disclosure may create a supercritical state by supplying carbon dioxide to a chamber containing the mixture, or conversely, by supplying carbon dioxide in a supercritical state to a chamber containing the mixture.

The first solvent may be one or more selected from a group consisting of water, an alcohol, and an organic solvent. Specifically, n-propyl alcohol (NPA) may be used.

The first solvent may be one or more selected from a group consisting of water, an alcohol, and an organic solvent. Specifically, an alcohol may be used. More specifically, n-propyl alcohol (NPA) may be used.

The alcohol may be one or more selected from a group consisting of methanol, ethanol, isopropyl alcohol (IPA), n-propyl alcohol (NPA), and n-hexanol.

The organic solvent may be one or more selected from a group consisting of N-methyl-2-pyrrolidone and glycerol.

The catalyst may include a carbon material; and a catalytic metal supported on the carbon material.

The carbon material may be one or more selected from a group consisting of carbon nanopowder, carbon black, carbon nanotube (CNT), carbon nanofiber (CNF), graphene nanosheet (GNS), Ketjen black, graphene, graphene oxide, and carbon nanosphere.

The carbon material may have a ratio of the D-band peak intensity to the G-band peak intensity (D/G ratio) of 1 or lower, specifically 0.95 or lower, when analyzed by Raman spectroscopy. When the D/G ratio of the carbon material exceeds 1, crystallinity may decrease, resulting in the increase of amount of the catalytic metal eluted after repeated electrochemical reactions.

The catalytic metal may be one or more selected from a group consisting of platinum (Pt), palladium (Pd), rhodium (Rh), ruthenium (Ru), nickel (Ni), cobalt (Co), iron (Fe), silver (Ag), gold (Au), copper (Cu), and tungsten (W). Most specifically, it may be platinum (Pt).

The binder may be one or more selected from a group consisting of Nafion, polyvinylidene fluoride (PVDF), and ethyl cellulose. Specifically, it may be Nafion.

The mixture may further contain an additive. The additive may be one or more of an inorganic material and an organic material.

The organic material may be a metal-organic framework (MOF).

The inorganic material may be one or more selected from a group consisting of SiO₂, Al₂O₃, TiO₂, ZrO₂, Y₂O₃ and WO₃.

For 12.5 mg of the catalyst, the amount of the first solvent may be 1 to 15 mL, specifically 1 to 10 mL, more specifically 2 to 7 mL, and most specifically 3 to 5 mL.

If the amount of the first solvent is below the lower limit for 12.5 mg of the catalyst, the nonuniformity of the prepared electrode may increase rapidly. And, if it exceeds the upper limit, the porosity of the electrode may decrease and the catalytic activity within the electrode may deteriorate rapidly. In addition, it is preferable that the above range is satisfied in that the elution amount of the catalytic metal is reduced when the amount of the first solvent satisfies the above range for 12.5 mg of the catalyst.

For 12.5 mg of the catalyst, the amount of the binder may be 80 to 200 μL, specifically 90 to 170 μL, more specifically 100 to 150 μL, and most specifically 110 to 130 μL. In addition, it is preferable that the binder satisfies the above-described range for 12.5 mg of the catalyst, in that the rate of change in the catalytic active area does not significantly change even after repeated electrochemical reactions.

If the amount of the binder is less than the lower limit for 12.5 mg of the catalyst, a three-phase interface may not be formed sufficiently, leading to rapid deterioration of the electrode performance. Conversely, if it exceeds the upper limit, the binder may block the active area of the catalyst, resulting in deterioration of the electrochemical performance.

For 12.5 mg of the catalyst, the amount of the first solvent may be 3 to 5 mL, and the amount of the binder may be 110 to 130 μL. In this case, it is particularly preferable in that no aggregation occurs at all even when the catalyst slurry undergoes rapid change between high and low temperatures 10 or more times.

### Supercritical State Creation Step

The supercritical state creation step is a step of creating a supercritical state by increasing the temperature and pressure of carbon dioxide.

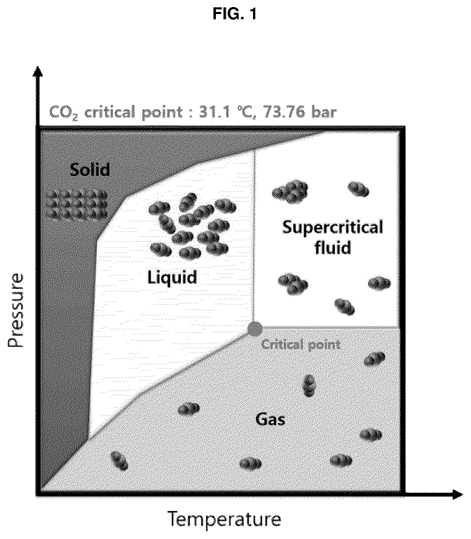

FIG. 1 shows the pressure-temperature phase diagram of carbon dioxide.

As shown in FIG. 1, carbon dioxide becomes a supercritical fluid at a temperature of 31.1° C. or higher and a pressure of 73.76 bar or higher. Therefore, the supercritical state creation step should be performed under the condition of a temperature of 32° C. or higher and a pressure of 73.76 bar or higher, specifically, at a temperature of 32 to 40° C. and a pressure of 150 bar or higher.

In particular, it is preferable that the pressure of the supercritical state creation step be 150 bar or higher, since the mixture cannot be brought into a completely supercritical state if the pressure is not increased enough.

The upper limit of the pressure of the supercritical state creation step is not particularly limited. But, since an excessively high pressure may cause stability problems, the upper limit may be the highest pressure at which stability problems do not occur. However, the upper limit of pressure is not limited specifically if it is possible to increase the pressure without stability problems.

If any the temperature and the pressure of the supercritical state creation step is below the lower limit, the supercritical treatment may be meaningless because carbon dioxide is not in a supercritical state.

### Supercritical Treatment Step

The supercritical treatment step is a step in which the carbon dioxide in a supercritical state present in the chamber containing the mixture is supercritically treated for a certain period of time.

The supercritical treatment step can be performed for 0.5 to 2 hours, specifically 0.6 to 1.7 hours, more specifically 0.7 to 1.5 hours, and most specifically 0.8 to 1.2 hours.

If the time of the supercritical treatment step is shorter than the lower limit, the degree of improvement in dispersibility may be insignificant. And conversely, if it exceeds the upper limit, the solvent may evaporate excessively, resulting in changes in the composition of the ink slurry and changes in the performance of the electrode.

The catalyst slurry prepared through the carbon dioxide supply step, supercritical state creation step, and supercritical treatment step described above is in a state where supercritical carbon dioxide coexists. The supercritically treated carbon dioxide can be recovered to prepare a catalyst. To this end, the method for preparing a catalyst slurry of the present disclosure may further include a recovery step.

### Recovery Step

In the recovery step, only the catalyst slurry can be recovered by lowering the temperature and pressure of the supercritically treated mixture to discharge gaseous carbon dioxide. The catalyst slurry can be recovered by removing the carbon dioxide by exposing it to room temperature and normal pressure.

The recovery step includes a first recovery step of lowering the temperature of the supercritically treated mixture; and a second recovery step of lowering the pressure of the supercritically treated mixture. The first recovery step and the second recovery step can be performed sequentially. It is more preferable that the first recovery step and the second recovery step are performed sequentially in that only the carbon dioxide can be discharged without ejection of the solvent.

The first recovery step can be performed by lowering the temperature at a rate of 0.03 to 5° C./min, specifically 0.05 to 3° C./min, more specifically 0.08 to 1° C./min, and most specifically 0.1 to 0.3° C./min.

If the rate of lowering the temperature in the first recovery step is outside the above range, the composition of the ink slurry may change rapidly.

The second recovery step can be performed by lowering the pressure at a rate of 1 to 10 bar/min, specifically 1.5 to 8 bar/min, more specifically 2 to 6 bar/min, and most specifically 2 to 5 bar/min.

If the speed of lowering the pressure in the second recovery step is below the lower limit, the process time may increase unnecessarily. And conversely, if it exceeds the upper limit, the temperature may decrease rapidly, causing some of the ink slurry to freeze, and the solvent to be eluted together. In addition, aggregation within the slurry may increase rapidly.

The first recovery step may be performed until the temperature of the supercritically treated mixture reaches room temperature, and the second recovery step may be performed until the pressure of the supercritically treated mixture reaches normal pressure.

Although not explicitly described in the examples and comparative examples below, catalyst slurries were prepared under different conditions, and left at room temperature for one week. Then, viscosity and dispersibility were analyzed.

As a result, when all of the following conditions were satisfied, there was almost no change in viscosity, and almost no aggregation occurred even after one week.

On the other hand, when any of the following conditions was not satisfied, the viscosity changed by at least three times compared to the initial value, and there was no effect of suppressing viscosity change over time. In addition, even when there was no aggregation initially, aggregation occurred on more than 15% of the area visible to the naked eye after one week.

(1) The first solvent is n-propyl alcohol (NPA), (2) the catalyst contains a carbon material having a ratio of D-band peak intensity to G-band peak intensity (D/G ratio) of 0.95 or lower when analyzed by Raman spectroscopy; and platinum supported on the carbon material; (3) the binder is Nafion, (4) the amount of the first solvent is 3 to 5 mL for 12.5 mg of the catalyst, (5) the amount of the binder is 110 to 130 μL for 12.5 mg of the catalyst, (6) the supercritical state creation step is performed at 32 to 40° C. at a pressure of 150 bar or higher, (7) the supercritical treatment step is performed for 0.8 to 1.2 hours, (8) the first recovery step is performed while lowering temperature at a rate of 0.1 to 0.3° C./min, and (9) the second recovery step is performed while lowering pressure at a rate of 2 to 5 bar/min.

Another aspect of the present disclosure provides a method for preparing a catalyst, which includes a step of preparing a catalyst slurry according to the method for preparing a catalyst slurry described above; and a step of preparing a catalyst by coating the catalyst slurry.

The coating may be performed by one or more method selected from a group consisting of doctor blade coating, roll coating, bar coating, slot die coating, comma coating, knife coating, gravure coating, micro-gravure coating, dip coating, flow coating, spin coating, and spray coating.

According to a specific exemplary embodiment, the coating may be performed by a spray coating method in which the catalyst slurry is sprayed onto a substrate using a spray.

The temperature of the substrate may be 60 to 100° C., specifically 70 to 90° C., and the spraying speed may be 3 to 15 L/h, specifically 7 to 12 L/h.

When the coating is performed by a spray coating method, if the spraying speed is below the lower limit, the structural stability of the catalyst being prepared may deteriorate. And conversely, if it exceeds the upper limit, a large number of defects may occur in the catalyst being prepared.

When the coating is performed by a spray coating method, if the temperature of the substrate is below the lower limit, surface properties may deteriorate, such as formation of wrinkles on the membrane. And conversely, if it exceeds the upper limit, damage may occur to the membrane structure.

Another aspect of the present disclosure provides a catalyst slurry prepared by the method for preparing a catalyst slurry.

Another aspect of the present disclosure provides a catalyst using the catalyst slurry.

Another aspect of the present disclosure provides a polymer electrolyte fuel cell (PEMFC), a solid oxide fuel cell (SOFC), and a secondary battery containing the catalyst.

Hereinafter, the present disclosure will be described in more detail through examples, etc. However, the scope and content of the present disclosure cannot be interpreted as being reduced or limited by the examples, etc.

### Example 1. Supercritical Treatment of Ink Slurry for Fuel Cell and Preparation of Electrode

### Supercritical Treatment of Ink Slurry for Fuel Cell

An ink slurry containing 12.5 mg of a platinum catalyst supported on crystalline carbon with a D/G ratio of 0.90 (Pt/HCC), 4 mL of n-propyl alcohol (NPA), and 120 μL of a Nafion binder was injected into a supercritical chamber. After that, carbon dioxide was slowly injected into the supercritical chamber, so that the pressure was increased to 60 to 70 bar. Then, a supercritical state was created by increasing the temperature of the supercritical chamber to 40° C. using a heater, so that the pressure in the chamber was increased to 150 bar or higher. Next, supercritical treatment was performed by maintaining the supercritical state for 1 hour. Next, the temperature and pressure were lowered to room temperature and normal pressure at a rate of 0.2° C./min and about 3.3 bar/min, respectively, and the ink slurry inside the supercritical chamber was recovered.

### Preparation of Electrode for Fuel Cell

An electrode was prepared by spraying the ink slurry onto a substrate at 80° C. at a rate of 10 L/h using an ultrasonic automatic spray equipment.

### Example 2

An electrode was prepared in the same manner as in Example 1, except that 0.8 mL of the solvent was used for 12.5 mg of the catalyst without changing the mass of the catalyst.

### Example 3

An electrode was prepared in the same manner as in Example 1, except that 17 mL of the solvent was used for 12.5 mg of the catalyst without changing the mass of the catalyst.

### Example 4

An electrode was prepared in the same manner as in Example 1, except that 78 μL of the binder was used for 12.5 mg of the catalyst without changing the mass of the catalyst.

### Example 5

An electrode was prepared in the same manner as in Example 1, except that 205 μL of the binder was used for 12.5 mg of the catalyst without changing the mass of the catalyst.

### Example 6

An electrode was prepared in the same manner as in Example 1, except that 140 μL of the binder was used for 12.5 mg of the catalyst without changing the mass of the catalyst.

### Comparative Example 1

An ink slurry was prepared by mixing 12.5 mg of a platinum catalyst supported on crystalline carbon (Pt/HCC), 4 mL of n-propyl alcohol (NPA), and 120 μL of a Nafion binder, and an electrode was prepared in the same manner as in Example 1, except that carbon dioxide was not injected.

### Test Example 1. Comparison of Dispersibility of Ink Slurry Before and After Supercritical Treatment

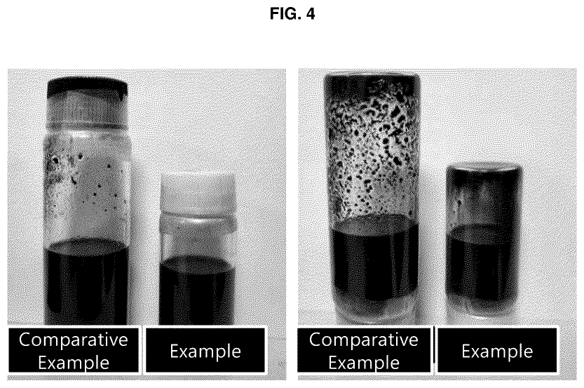

The photographic images of the ink slurries prepared in Example 1 and Comparative Example 1 are shown in FIG. 4.

FIG. 4 shows the photographic images of the ink slurries prepared in Example 1 and Comparative Example 1 of the present disclosure.

Referring to FIG. 4, when the vials containing the ink slurries prepared in Example 1 and Comparative Example 1 were turned upside down (right image in FIG. 4), large-sized aggregates attached to the wall were visible for the comparative example, whereas large-sized aggregates like those in the comparative example were not visible for the example, confirming that the method for preparing a catalyst slurry of the present disclosure can improve dispersibility.

### Test Example 2

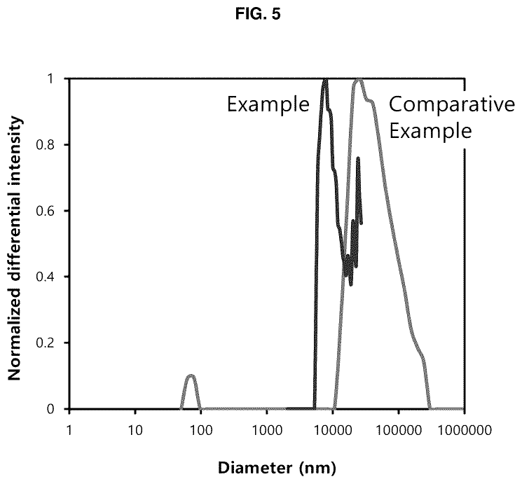

The particle size of the ink slurries prepared in Example 1 and Comparative Example 1 was analyzed by dynamic light scattering (DLS), and the result is shown in FIG. 5.

FIG. 5 shows the result of dynamic light scattering (DLS) analysis of the ink slurries prepared in Example 1 and Comparative Example 1 of the present disclosure. In FIG. 5, the red graph represents the comparative example not subjected to supercritical treatment, and the blue graph represents the example subjected to supercritical treatment.

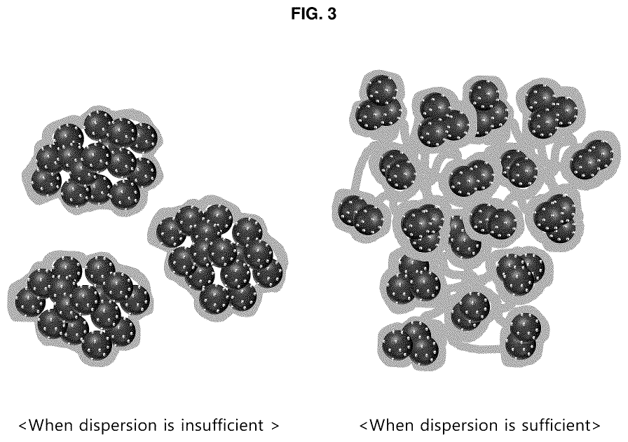

Referring to FIG. 5, the ink slurry prepared in Comparative Example 1 exhibited a particle size of 10,000 nm or larger, while the ink slurry prepared in Example 1 exhibited a particle size of 10,000 nm or smaller. Through this, it can be seen that the supercritical treatment improves dispersibility as particle aggregation is decreased, as shown in FIG. 3.

### Test Example 3. Analysis of Electrode Surface

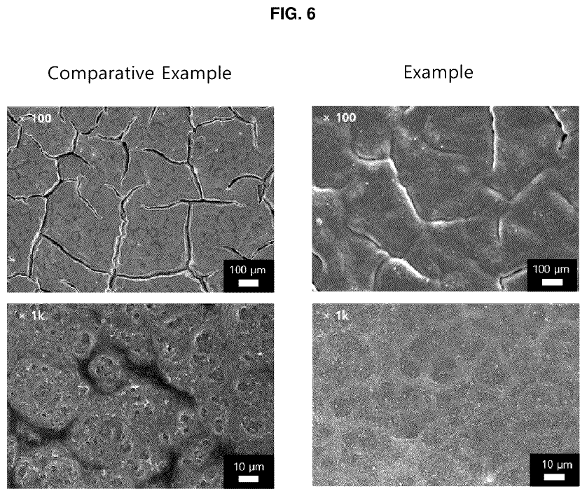

The surface of the electrodes prepared in Example 1 and Comparative Example 1 was analyzed using a scanning electron microscope (SEM), and the result is shown in FIG. 6.

FIG. 6 shows the scanning electron microscopic (SEM) images of the surface of the electrodes prepared in Example 1 and Comparative Example 1 of the present disclosure.

Referring to FIG. 6, it can be seen from the 100× magnification images that, whereas the electrode prepared in the comparative example has many cracks, the electrode prepared in the example has relatively fewer cracks. In addition, it can be seen from the 1000× magnification images that, whereas the electrode prepared in the comparative example has voids corresponding to cracks and particles are aggregated together, the electrode prepared in the example does not show the phenomenon of particle aggregation.

### Test Example 4. Evaluation of Electrode Performance

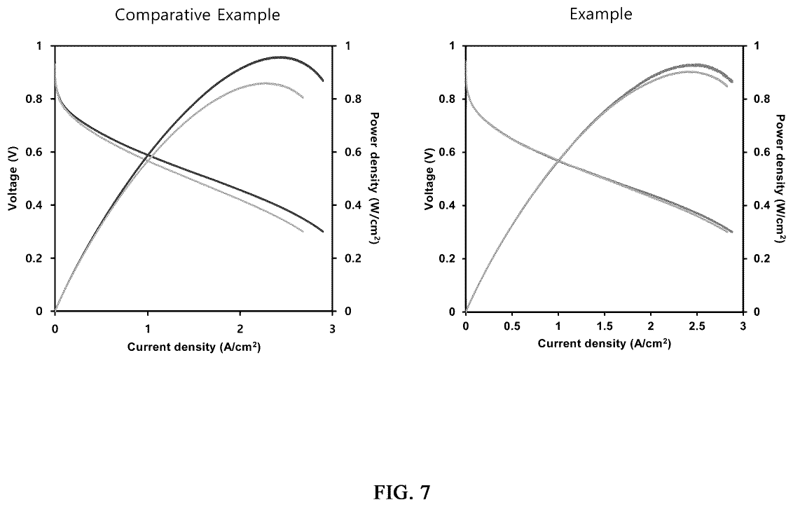

A fuel cells was prepared using the electrode prepared in Example 1 or Comparative Example 1 as an air electrode. Humidified air was injected into the air electrode, and electrode performance was measured before and after accelerated aging, during which the carbon support was electrochemically oxidized rapidly, by a single cell test. The result is shown in FIG. 7.

FIG. 7 shows a result of evaluating the electrochemical performance of the fuel cells using the electrodes prepared in Example 1 and Comparative Example 1 of the present disclosure before and after accelerated aging.

In FIG. 7, the initial performance of the electrode prepared in the comparative example is shown in blue color, and the performance after oxidation by the accelerated aging method is shown in sky blue color. And, the initial performance of the electrode prepared in the example is shown in red color, and the performance after oxidation by the accelerated aging method is shown in orange color.

Referring to FIG. 7, it can be seen that the performance after the accelerated aging method is higher for the electrode prepared in Example 1 (905 mW/cm²) by 4.97% as compared to that of the electrode prepared in Comparative Example 1 (860 mW/cm²). As a result, whereas the performance deterioration rate after accelerated aging decreased by 10.2% for Comparative Example 1, it decreased by 3.31% for Example 1, confirming that the durability of the fuel cell was improved after supercritical treatment.

### Test Example 5

After preparing fuel cells using the electrodes prepared in Examples 1 to 6 and Comparative Example 1 in the same manner as in Test Example 4, an accelerated aging test was performed for 2000 cycles. Then, the electrolyte was collected and ICP analysis was performed to measure platinum eluted from the electrode catalyst. The relative values with respect to the platinum elution amount for Example 1 as 1 are shown in Table 1.

TABLE 1

| | Platinum elution amount |
|---|---|
| Example 1 | 1 |
| Example 2 | 12 |
| Example 3 | 9 |
| Example 4 | 7 |
| Example 5 | 11 |
| Example 6 | 5 |
| Comparative Example 1 | 15 |

As shown in Table 1, the platinum elution amount was the highest for Comparative Example 1, wherein supercritical treatment was not performed, and the platinum elution amount varied depending on the mixing ratio of the catalyst, the first solvent, and the binder among the examples wherein supercritical treatment was performed.

### Test Example 6

10,000 cycles of potential sweep were performed in a range of 0.6 to 1 V at a temperature of 75° C. and a relative humidity of 100%. The rate of change of catalytic active area before and after the cycles was measured and shown in Table 2.

TABLE 2

| | Change rate (%) |
|---|---|
| Example 1 | 32.5 |
| Example 2 | 51.8 |
| Example 3 | 62.3 |
| Example 4 | 78.5 |
| Example 5 | 74.3 |
| Example 6 | 48.2 |
| Comparative Example 1 | 81.6 |

As shown in Table 2, the rate of the change in the active area of the platinum catalyst was the highest for Comparative Example 1, which did not undergo supercritical treatment. And, among the examples that underwent supercritical treatment, the rate of the change in the active area of the catalyst varied depending on the mixing ratio of the first solvent and the binder to the catalyst.

What is claimed is:

1. A method for preparing a catalyst slurry, comprising:
a carbon dioxide supply step of supplying carbon dioxide to a chamber comprising a mixture of a catalyst and a binder added to a first solvent;
a supercritical state creation step of increasing the pressure and temperature of the chamber to create a supercritical state; and
a supercritical treatment step of supercritically treating the mixture under the supercritical state.

2. The method for preparing a catalyst slurry, comprising:
a supercritical state creation step of creating a supercritical state by increasing the pressure and temperature of carbon dioxide;
a carbon dioxide supply step of supplying the carbon dioxide in a supercritical state to a chamber comprising a mixture of a catalyst and a binder added to a first solvent; and
a supercritical treatment step of supercritically treating the mixture to which the supercritical carbon dioxide has been supplied.

3. The method for preparing a catalyst slurry according to claim 1, which further comprises a recovery step of lowering the temperature and pressure of the supercritically treated mixture to recover the catalyst slurry.

4. The method for preparing a catalyst slurry according to claim 1, wherein the first solvent is one or more selected from a group consisting of water, an alcohol, and an organic solvent.

5. The method for preparing a catalyst slurry according to claim 1, wherein
the catalyst comprises a carbon material; and a catalytic metal supported on the carbon material, and
the carbon material is one or more selected from a group consisting of carbon nanopowder, carbon black, carbon nanotube (CNT), carbon nanofiber (CNF), graphene nanosheet (GNS), Ketjen black, graphene, graphene oxide, and carbon nanosphere.

6. The method for preparing a catalyst slurry according to claim 5, wherein the catalytic metal is one or more selected from a group consisting of platinum (Pt), palladium (Pd), rhodium (Rh), ruthenium (Ru), nickel (Ni), cobalt (Co), iron (Fe), silver (Ag), gold (Au), copper (Cu), and tungsten (W).

7. The method for preparing a catalyst slurry according to claim 1, wherein the binder is one or more selected from a group consisting of Nafion, polyvinylidene fluoride (PVDF), and ethyl cellulose.

8. The method for preparing a catalyst slurry according to claim 1, wherein the amount of the first solvent is 1 to 15 mL for 12.5 mg of the catalyst.

9. The method for preparing a catalyst slurry according to claim 1, wherein the amount of the binder is 80 to 200 μL for 12.5 mg of the catalyst.

10. The method for preparing a catalyst slurry according to claim 1, wherein the amount of the first solvent is 3 to 5 mL and the amount of the binder is 110 to 130 μL for 12.5 mg of the catalyst.

11. The method for preparing a catalyst slurry according to claim 1, wherein the supercritical state creation step is performed at 32 to 40° C. and a pressure of 73.76 bar or higher.

12. The method for preparing a catalyst slurry according to claim 1, wherein the supercritical treatment step is performed for 0.5 to 2 hours.

13. The method for preparing a catalyst slurry according to claim 1, which further comprises:
a first recovery step of lowering the temperature of the supercritically treated mixture; and
a second recovery step of lowering the pressure of the supercritically treated mixture.

14. The method for preparing a catalyst slurry according to claim 13, wherein the first recovery step is performed while lowering the temperature at a rate of 0.03 to 5° C./min.

15. The method for preparing a catalyst slurry according to claim 13, wherein the second recovery step is performed while lowering the pressure at a rate of 1 to 10 bar/min.

16. The method for preparing a catalyst slurry according to claim 1, which further comprises:
a first recovery step of lowering the temperature of the supercritically treated mixture; and
a second recovery step for lowering the pressure of the supercritically treated mixture, wherein
the first solvent is n-propyl alcohol (NPA),
the catalyst comprises a carbon material having a ratio of D-band peak intensity to G-band peak intensity (D/G ratio) of 0.95 or lower when analyzed by Raman spectroscopy, and platinum supported on the carbon material,
the binder is Nafion,
the amount of the first solvent is 30 to 33 mL for 100 mg of the catalyst,
the amount of the binder is 950 to 970 μL for 100 mg of the catalyst,
the supercritical state creation step is performed at 32 to 40° C. and a pressure of 150 bar or higher,
the supercritical treatment step is performed for 0.8 to 1.2 hours,
the first recovery step is performed while lowering the temperature at a rate of 0.1 to 0.3° C./min, and
the second recovery step is performed while lowering the pressure at a rate of 2 to 5 bar/min.

17. A method for preparing a catalyst, comprising:
a step of preparing a catalyst slurry according to claim 1; and
a step of preparing a catalyst by coating the catalyst slurry.

18. The method for preparing a catalyst according to claim 17, wherein
the coating is performed by spraying the catalyst slurry onto a substrate using a spray,
the temperature of the substrate is 60 to 100° C., and
the spraying speed is 3 to 15 L/h, specifically 7 to 12 L/h.

19. A catalyst slurry prepared by the method according to claim 1.

20. A catalyst comprising the catalyst slurry according to claim 19.

21. A catalyst according to claim 20, characterized in that the catalyst is a catalyst for a polymer electrolyte fuel cell (PEMFC), a solid oxide fuel cell (SOFC), or a secondary battery.

22. A fuel cell comprising the catalyst according to claim 20.
